(19) United States
(12) Patent Application Publication
(10) Pub. No.: US 2006/0101511 A1
(43) Pub. Date: May 11, 2006

(54) Dynamic system and method for securing a communication network using portable agents

(76) Inventors: Laurent Faillenot, Paris (FR); Olivier Schott, Paris (FR); Nicolas Stehle, Paris (FR)

Correspondence Address: FULBRIGHT & JAWORSKI, LLP, 666 FIFTH AVE, NEW YORK, NY, 10103-3198, US

(21) Appl. No.: 10/541,805

(22) PCT Filed: Jan. 8, 2004
(86) PCT No.: PCT/FR04/50009

§ 371 Date: Jul. 8, 2005

(30) Foreign Application Priority Data
Jan. 23, 2003 (FR) 03/00719

(51) Int. Cl. G06F 15/16

(52) U.S. Cl. 726/13

(57) ABSTRACT

The invention relates to a device that is placed in a computer network for securing the communication flows passing through the device. The communication flows are secured using portable codes, known as portable agents, which can be downloaded from a remote terminal. The portable agents cannot be executed by the device until they have been compiled by a compiler which is present in the device, at which point they become executable agents. The compiler translates the portable agents, which are written in a language that is independent of the processor, into executable agents written in the language of the processor of the device, while placing controls on the functions performed by the agent. The executable agents are then executed in the device in accordance with the communication flows passing through it and a security policy, which can also be downloaded from a remote terminal.

Computer network security is a critical element for a company, and it involves securing both communications and accesses to the elements of the network. With the rise of the Internet and the business opportunity it represents, more and more organizations have opened their networks to the outside. But network communication and security are two concepts that are highly incompatible, and the threats that ensue from an unsuccessful marriage of these two concepts have often led companies to the only two possible solutions offered by the market: not opening up to the Internet, or shielding incoming and outgoing communication flows at enormous additional cost. The market for security has therefore exploded: proposals for securing enterprise networks abound, but are still focused on protecting the boundaries between two subnetworks (usually an enterprise network and the Internet). Although the Internet represents an undeniable potential threat, most attacks and threats come from the inside. Despite this fact, the current market for security continues to offer solutions that are less and less responsive to companies' needs, and more generally, to the needs of network users.

The methods used to secure computer networks are essentially based on packet filtering technology. This technology makes it possible to authorize the passage of network communication flows while exerting control over these flows. The best (and most widespread) illustrations are “firewalls” (IEEE Communications Magazine, Vol. 32, No. 9, September 1994, pages 50-57, S. M. Bellovin et al., “Network Firewalls”) and filtering gateways at the application level (designated by the term “Proxy”). These two types of network entities create a barrier between two subnetworks and perform their filtering in accordance with certain security rules, which are coherently defined in a security policy. Other entities complete the security supply by offering complementary services including, among other things, intrusion detection systems (or IDS), antivirus products, virtual private network gateways (known as VPN gateways), hardware and software encryption tools, authentication client/servers, log servers, etc. Despite the variety of the products, their many limitations are becoming more and more inconvenient for companies. The demand for them has changed along with the computer security sector. Network protection should not be focused on the points of contact between several subnetworks but should be centered on the protection of each of the elements constituting the network.

From this new point of view, all of the services offered by the various security proposals should be able to work for each element of the network. The current technologies were not thought of in this way. Thus, there are two main problems hampering the move to global, homogenous network security: the specialization of the security supply and the cost of this type of security. In essence, as a result of the technology currently used, the entities dedicated to securing networks are limited to a pre-defined role. A firewall cannot be used for anything other than filtering; its function cannot be changed, nor can new functionalities be added to it. Consequently, it is necessary to combine a large number of products in order to obtain a wide range of services (and hence good security) at a given point in the network. This large number of products inevitably entails high costs for acquisition, training and maintenance without reducing the risk of failures, due to the fact that these products are not necessarily developed to work together. Given that the cost of protecting a single point is already relatively high, this cost would become prohibitive in the case of full network protection.

Beyond the cost, the multitude of specialized products severely complicates network administration and the implementation of an effective and coherent security policy. Each product uses its own administrative interface, and this plurality makes it impossible to provide an organized view of the network. These clarity and coherency problems not only result in the presence of loopholes in the security policy, but also slow down a company's reaction time in implementing a security policy when faced with threats.

In the great majority of the current solutions for securing networks, the central element is the firewall. The company's security policy is centered on this firewall, around which other entities providing complementary security services may gravitate. An administrative server makes it possible to define the various elements of the network (computers, network peripherals, network services, users, etc.) and to define the filtering rules between these various elements. These filtering rules constitute the security policy, which is then sent to the firewall; the authorization or rejection of the passage of the packets of communication flows is then determined by the firewall in accordance with the filtering rules. Historically, the sending of the security policy constituted an improvement in firewalls, making it possible to eliminate the rigidity and the lack of scalability of a configuration written directly into the firewall. In addition, the filtering rules were changed, making it possible to filter new protocols by proposing to define one's own network elements in the administrative server. All of these new developments advanced firewall technology to the so-called “third-generation firewall” stage. Nevertheless, burgeoning network security needs require a new advance, which cannot be provided by firewalls, no matter what their generation. This advance is defined by the capability for the same network entity to perform any type of operation on the packets, whether it be firewall-type filtering, intrusion detection, virus detection, network service quality, etc. In fact, it is becoming essential to analyze and control the information traveling in the flows authorized by the firewall, since these flows can be used for hacking purposes. In the layered model of the OSI standard (ISO/IEC 7498-1: 1994), one of the implementations of which is the TCP/IP protocol (Internet Protocol: RFC 791, Transmission Control Protocol: RFC 793), firewall filtering is performed at the level of the network and transport layers. The highest layer is the application layer, which contains the information transmitted by the client/server applications. There is a very large number of protocols in the application layer, which represents an equally large number of information flows capable of containing an attack. Every day, new loopholes are revealed in one protocol or another, allowing computer hackers to attack any system that is hosting a service using this protocol. A security product must therefore be able to acquire new services in order to keep up to date with the threats. With the same security policy, an administrator should be able to define the services he wants to implement in each of the points in the network, based on the users of the network and the threats of the moment.

One method for doing this is to use mobile codes. The mobile code theory is based on the presence of a module that is capable of executing code that is supplied to it remotely. This makes it possible to maintain a homogeneous platform that is capable of running any type of program. One of the implementations of the mobile code concept is based on the presence of a virtual machine. A virtual machine emulates a processor (i.e., it simulates, in another piece of hardware, the operation of this processor). It is a virtual processor with its own language. Therefore, it uses working registers and executes the instruction sequences of a code compiled in its own language. This is done not by hardware, but by software.

The virtual machine gives a system scalability, allowing new functionalities to be added to it. It also provides independence from the system and hence, portability.

Some of the most advanced firewalls incorporate a virtual machine in order to filter packets through a mobile code generated from the security policy defined in the administrative server, as described in U.S. Pat. No. 5,606,668 or U.S. Pat. No. 5,835,726. This method of using the virtual machine, although quite useful, continues to limit the role of the firewall to a simplistic filtering role, since the virtual machine is limited to authorizing or rejecting the passage of packets in accordance with security rules.

Although it provides several advantages, the virtual machine has one major flaw: a substantial drop in performance. In essence, the virtual machine emulates a processor on top of a real processor, thereby creating an additional layer. The mobile codes (also called applets in computer jargon) are executed by the virtual machine, which is itself executed by the processor. This software abstraction layer causes a drop in performance that can be critical in real-time network flow processing applications.

Another possible implementation of the mobile code concept consists of sending the native code (which, conventionally, we'll call an agent) directly to a device. This agent is a code compiled in the language of the processor. This solution is optimal in terms of execution speed. Since the agents are executed directly by the processor, they can be optimized in accordance with the particular characteristics of this processor. They are compiled in a previous phase (generally at the time the agent is developed). The compiler then translates the code of the agent. From a code developed in a high-level language (i.e., one that is easily understandable to a human being because of its similarity to a natural language), the compiler generates a translation of the code into a low-level language (understood by the machine). The compilation of a code comprises various steps in which the code undergoes several transformations. “Compilation is performed by a compiler. According to a simplified definition, a compiler is a program that reads a program written in a first language—the source language—and translates it into an equivalent program written in another language—the target language.” (Compilers: Principles, Techniques and Tools, Alfred Aho, Ravi Sethi and Jeffrey Ullman, InterEditions, 1989 [French edition]). A compiler works in different phases that transform the source program from one representation to another. The first phase is lexical analysis, which groups the characters of a source program into lexical units (words or symbols). Next comes syntactic (also called grammatical) analysis, which groups the lexical units into syntactic structures which will be used by the compiler to synthesize its result. The next phase, semantic analysis, uses the syntactic structure to check whether the source program contains semantic errors (for example, a real number is used as a character). The compiler then constructs an intermediate representation of the source program that is both easy to produce and easy to translate into the target language. A code optimization phase then tries to improve the intermediate code so that the resulting code is executed more rapidly. The final phase of the compiler consists in the production of a target code. The creation of an executable program generally requires the use of several other programs which are cousins of the compiler. In fact, the programmer generally creates a skeleton program, which is modified by a preprocessor in order to obtain a source program. The latter is compiled by the compiler into a target program, generally in an assembly language. The latter is transformed by an assembler into translatable machine code, which is itself completed by a binder/loader with libraries or translatable object files in order to obtain an absolute machine code that can be understood by the computer. Thus, to simplify, there are various phases that constitute the compilation: in a first step, the various files composing the code are individually compiled into an assembly language (a compilation phase that incorporates the many steps for analyzing a source code in a high level language), then they are translated from the assembly language (a low-level language) to the machine language, i.e. a binary language (the assembly phase). This produces object files, which are the translation of the source files into machine language. The final phase generates the executable itself; the files are bound to one another so as to form a single binary file (the so-called link-editing phase). The compiler must solve all the dependencies of each of the object files in order to form a coherent executable. The major drawback of this method is that it is incompatible with independence from the platform, and with a proprietary language optimized for the needs of said platform. In essence, the compiled codes are not at all portable, since they depend on the processor of the device. Only the source files are portable. The solution of distributing the source files poses many problems: the code can be read and modified by anyone, which can be a problem for a company that is anxious to protect an expertise, a know-how, or simply confidential algorithms. Moreover, the source files need to be compiled for the appropriate processor. It seems unlikely that a customer who has acquired various devices (with different processors) would be prepared to perform the compilations of the source codes, with the right compiler each time, in order to obtain different binary versions of the same source code, then organize the sending of the right compiled code to the various devices. Furthermore, the fact that it is possible to send the device codes that are compiled in the language of its processor can be very dangerous. In fact, it allows any user, including an ill-intentioned user, to develop a code that makes it possible to have full control over the device. In order to limit the capabilities of the agents, it is necessary to monitor their execution, which substantially affects performance.

The invention that is the subject of the present patent makes it possible to solve the aforementioned problems without having the drawbacks of the prior art. The invention makes it possible to retain the advantages of mobile codes while increasing performance. It overcomes the problems and the limitations of the existing technologies by offering an innovative solution.

### DESCRIPTION OF THE INVENTION

The general scope of the invention concerns a method for securing computer networks by controlling communication flows between elements of said networks. This control is exerted by performing operations on the packets of the communication flows using a flexible, dynamic, scalable method that can be easily managed and homogeneously deployed throughout the network.

The present invention describes a method for the scalable processing of network communication flows, this processing being performed in real time.

In addition, the present invention makes it possible to perform any type of advanced packet processing at all the levels of the OSI model, and in particular at the level of the application layer.

In addition, the present invention makes the system scalable in terms of new functionalities for a given type of operation (it is possible, for example, to easily add new filtering functionalities to a firewall or new viral signatures to an antivirus).

In addition, the present invention allows a system to change a type of operation in real time (a firewall can become an antivirus or an intrusion detection system, or even a VPN gateway).

In addition, the present invention allows a system to make all of the above-mentioned changes dynamically and in real time.

In addition, the present invention makes it possible to provide effective and customizable protection homogeneously in any point of the network.

In addition, the present invention provides solutions in terms of performance and execution speed, thus allowing an embedded system to efficiently process communication flows in real time.

In addition, the system can protect itself from the codes that are sent to it for the purpose of performing new operations, without impacting performance.

The present invention concerns a method for performing the analysis and/or selective modification and/or selective filtering of data packets passing through a device placed on an edge in a computer network, said device comprising a processor that runs a compiler and a piece of software in accordance with a security policy, said software being designed to filter said data packets, authorizing or not authorizing their passage in accordance with said security policy, said method being characterized in that it comprises the following steps:

the step of defining said security policy by means of portable agents written in a computer language that is independent of the language of said processor and dedicated to the analysis and/or the selective modification and/or the selective filtering of said data packets;

the step, for said software, of automatically calling said compiler in order to perform a compilation for translating said portable agents into executable agents written in the language of said processor;

the step of running said software in order to filter said data packets passing through said device, authorizing or not authorizing their passage in accordance with said security policy;

the step of analyzing said data packets authorized by said software to pass through said device, by executing said agents executable by said processor; and/or

the step of selectively modifying said data packets authorized by said software to pass through said device, by executing said agents executable by said processor; and/or

the step of selectively filtering said data packets authorized by said software to pass through said device, by executing said agents executable by said processor.

Thus, the present invention is characterized by a device that connects to the network. The connection to the network creates a separation of the network into two subnetworks, making it possible to intercept all of the communication flows from one subnetwork to the other.

This method allows a network device to receive a security policy composed of conventional filtering rules as well as packet processing agents. These agents are automatically compiled in the device, the compilation being triggered by the embedded software dedicated to the filtering of data packets; they then become directly executable by the processor, which is optimal in terms of execution speed. Thus, the method allows a device to modify its own behavior based on the agents that are downloaded, which makes it completely scalable. In fact, this change in behavior can be a global change in the role of the device (a firewall becomes an antivirus, for example), or a simple updating of the functionalities (an addition of new signature detections, for example). Moreover, the agents are sent in a language that is independent of the processor of the device. This independence ensures their portability to devices using different processors. Furthermore, this makes it possible to design a proprietary language that is halfway between a high-level language and the native language of the processor, this proprietary language having functionalities that can be adapted as necessary to the analysis, modification and filtering of packets in network communication flows and being able to be restricted to functions that present no danger for the device. Thus, the agents are unintelligible, which protects the author's intellectual property. In operation, the device intercepts all of the packets that pass through it, and the embedded software performs a preliminary filtering of the data packets in accordance with a security policy. For the packets that are authorized by the embedded software in keeping with the security policy, agents will be executed in order to perform complementary operations. This makes it possible to optimize the performance of the device by performing a first filtering of the packets prior to executing the agents.

Advantageously, the security policy also includes a definition of the various objects of said computer network.

Advantageously, the security policy also includes a definition of the various services of said computer network.

Advantageously, the security policy also comprises a definition of the various users of said computer network.

Advantageously, the method according to the invention includes the step of generating configuration parameters, making it possible to configure said portable agents based on said users of said computer network.

Advantageously, the security policy also includes a definition of said device.

This allows the security policy to include multiple parameters representing various aspects of the network. It is therefore possible to define filtering rules between elements of the network or between users and services, or even between the device and the various services. To all of these types of filtering, it is possible to add agents that will perform additional operations. The software embedded in the device then performs the filtering in accordance with the rules of the security policy and, for the packets authorized by these rules, triggers the execution of the agents that have been added for these rules.

Thus, the device is not limited to doing the work of a firewall (packet filtering). In fact, it is possible, at the level of the filtering rules of the embedded software, to authorize all of the packet flows to pass through the device (which has the effect of deactivating the firewall functionality), while adding agents dedicated, for example, to the filtering of intrusion attempts.

Advantageously, said computer language of said portable agents is a low-level language that is dedicated to operations on said data packets of said computer network and that makes it possible to monitor and to limit the possible actions of said portable agents inside said device.

Thus, the agents cannot be read because they are unintelligible to human beings. Moreover, they can initially be developed in a high-level language at the time they are designed, then compiled and subsequently delivered in this low-level language. The provider of the agents thus protects the sources of its agents. The language in which the agents are written is specially adapted to the processing of network communication flows and makes it possible to maintain control over the capabilities of the agent inside the device. In essence, an agent that is compiled directly into the language of the device's processor can potentially cause serious damage to the device if there is no monitoring during its execution. Any monitoring of the agent during its execution would significantly affect its performance. By limiting the capabilities of the agent in the language in which it is written and in the compiler of this language, the agents are monitored during the compilation and not during execution, thus increasing performance. Furthermore, it becomes possible to design an improved version of the invention by optimizing the embedded compiler; in this case, the compiler need only perform a translation from a low-level language to the language of the processor, which is much faster than a complete compilation. This facilitates the implementation of the compiler in new devices with different processors, while retaining all of the advantages in terms of the portability, confidentiality and security of the device. In fact, the lexical, syntactic, and semantic analysis phases that are specific to the compilation of a high-level source code need no longer be performed.

Advantageously, the method according to the invention includes the step of defining, in a server remote from said device, said security policy.

Advantageously, the method according to the invention includes the step of defining, in said device, said security policy.

The security policy can be configured remotely and sent to the device via the network. It can also be defined directly in the device, for example with a web server embedded in the device or via a serial port of the device.

Advantageously, the method according to the invention includes the step of authenticating the non-authenticated user or users of said device.

Advantageously, said security policy also includes a definition of said authenticated users of said device.

Advantageously, the method according to the invention includes the step of authenticating said non-authenticated user or users of said device using a identification means associated with said device.

Advantageously, the method according to the invention includes the step of authenticating said non-authenticated user or users of said device using a client/server application whose server application is contained in said device.

It then becomes possible to define a security policy based on the users of the device. Thus, the method makes it possible to define a security policy and agents that are specific to the users of the device; in the same device, different users will be assigned different security policies. To give a purely illustrative and nonlimiting example of the possibilities for application of the invention, it is possible to implement a security policy in which an intern, after having been authenticated, will have access to only non-confidential network services and servers, while a developer will be able to access the development servers.

There are several types of methods for authenticating the users of the device: using an element of the device (to give a purely illustrative and nonlimiting example of the possibilities for application of the invention, this could be, among other things, a smart card reader or a biometric identifier) or using a client/server type mechanism wherein the authentication server would reside in the device. The authentication information can then be verified in the device or in a remote server in which the security policy is stored.

Advantageously, the method according to the invention includes the step of executing functions from a function library contained in said software and called by said executable agents.

This makes it possible give the executable agents a set of functions that correspond to current requirements and to the specific characteristics of the device.

Advantageously, the method according to the invention includes the step of executing specialized functions, from said function library, for managing a cache of said data packets.

Advantageously, the management of said cache of said data packets comprises the following steps:

the step of storing in said cache, after the execution of said executable agents, packet information concerning said data packets, as well as said data packets themselves when they have been modified during said execution;

the step, upon the arrival of an incoming packet in said device, of verifying, based on said packet information stored in said cache, whether said incoming packet is a packet that has already been received;

the step, when said incoming packet is not a packet that has already been received, of executing said executable agents;

the step, when said incoming packet is a packet that has already been received, of determining, using said packet information stored in said cache, whether said already received packet has been modified by said executable agents;

the step, when said already received packet has been modified by said executable agents, of transmitting a version of said already received packet stored in said cache to said computer network, without executing said executable agents;

the step, when said previously received packet has not been modified by said executable agents, of transmitting said incoming packet as is to said computer network, without executing said executable agents.

This set of functions allows the agents to use a type of management that is adapted to the packet cache. The packet cache makes it possible for the agents not to see the data packets that have already been received, thus maintaining a coherent flow view. In addition, the data packet cache makes it possible to substantially improve the performance of the device by bypassing the execution of the agents and directly sending the already received packet—if it was not modified by the agents the first time it was received—or the modified version of it stored in the data packet cache—if it was modified by the agents the first time it was received.

Advantageously, the method according to the invention includes the step of executing specialized functions, from said function library, for managing the network and transport layers of the communication protocol used.

Advantageously, the management of said network and transport layers comprises the following steps:

the step of storing protocol information from said network and transport layers of said data packets passing through said device, for the purpose of monitoring the various flows of said data packets;

the step of storing any modifications of said data packets performed by said executable agents;

the step of updating said protocol information from said network and transport layers of said data packets passing through said device, based on said protocol information and said stored modifications, in said data packets so as to maintain consistency in the flows of said data packets.

The method makes it possible to save the important information in the authorized flows in order to be able to modify and correctly analyze the information in the data packets being processed. To give a purely illustrative and nonlimiting example of the possibilities for application of the invention, the saved information can be the sequence and acknowledgement numbers of the TCP protocol (as defined in the above-mentioned RFC 793), which makes it possible to enlarge or reduce the data packets, recalculate the checksums of the headers, save information sent in the flow such as a user name, an important keyword, a call of a special command, etc.

Advantageously, the method according to the invention includes the step of executing specialized functions, from said function library, for searching for regular patterns and expressions.

Using these functions, the agents can perform complex searches for patterns in the packets, which often requires a data packet analysis. To give a purely illustrative and nonlimiting example of the possibilities for application of the invention, these functions can be, among others things, string comparison functions, memory block functions, regular expression functions, functions for simultaneously searching for several strings in a memory block, etc.

Advantageously, the method according to the invention includes the step of executing specialized functions, from said function library, for communicating between said executable agents.

In many cases, an agent will need to exchange information with the other agents in order to warn them, or be warned, of imminent events. A purely illustrative and nonlimiting example of the possibilities for application of the invention is that of an agent that has detected the presence of a virus and decides to prohibit the sending of the packet. It must then warn the other agents that the packet has been destroyed.

Advantageously, the method according to the invention includes the step of executing specialized functions, from said function library, for communicating between said executable agents and said objects of said computer network.

The method makes it possible to give the agents the capability to dialog with network components in their communication protocol. This makes it possible, among other things, to reconfigure peripherals or exchange information. In essence, an effectively protected network is a network in which each element has a coherent role in the security policy. It is important that each component of the network be able to participate in the network's security. A purely illustrative and nonlimiting example of the possibilities for application of the invention is that of an agent using the functions from the library to reconfigure the security policy of a router via the SNMP protocol (Simple Network Management Protocol: RFC 1157) or to send logs (information messages) to existing log servers (like syslog for example: RFC 3164).

Advantageously, the method according to the invention includes the step of associating specialized hardware components of said device with functions from said function library in order to accelerate the execution of said functions.

In order to optimize the performance of the device, the most often used functions from the function library can be integrated directly into the device at the hardware level; for example, encryption or pattern search algorithms can be hardwired into a dedicated coprocessor. The hardware acceleration makes it possible to obtain a substantial increase in performance for real-time processing devices.

Advantageously, the method according to the invention includes the step of modifying said security policy by executing said agents executable by said processor.

In order to obtain global and coherent security for the device and for the network in general, the agents must be able to influence the current security policy. In essence, the agents can perform highly advanced analyses on the packets in order to detect, among other things, network attacks, intrusions, abnormal behaviors, viruses, exceeded quotas, or patterns not authorized to pass through the network. All of these analyses lead the agents to make decisions for modifying the security policy. A purely illustrative and nonlimiting example of the possibilities for application of the invention is that of an agent that is responsible for detecting the port negotiation for the data channel of the FTP protocol (File Transfer Protocol: RFC 959) and that must decide whether or not to authorize the packets from the data channel to pass through the device. Another example is that of an agent that detects an attempted attack from a terminal A and then adds a filtering rule prohibiting any communication with the terminal A.

The invention also concerns a system for performing the analysis and/or selective modification and/or selective filtering of data packets, said system comprising:

a device passed through by said data packets and placed on an edge in a computer network, said device comprising a processor that runs a compiler and a piece of software in accordance with a security policy, said software comprising filtering means for filtering said data packets passing through said device, authorizing or not authorizing their passage in accordance with said security policy (PS), and,

portable agents designed to define said security policy, written in a computer language that is independent of the language of said processor and dedicated to the analysis and/or selective modification and/or selective filtering of said data packets;

said compiler being automatically activated by said software in order to translate said portable agents into executable agents written in the language of said processor,

said executable agents being executed by said processor in order to:

analyze said data packets authorized by said software to pass through said device, and/or

selectively modify said data packets authorized by said software to pass through said device, and/or

selectively filter said data packets authorized by said software to pass through said device.

Advantageously, said security policy also includes a definition of the various objects of said computer network.

Advantageously, said security policy also includes a definition of the various services of said computer network.

Advantageously, said security policy also includes a definition of the various users of said computer network.

Advantageously, said system also includes means for generating configuration parameters for configuring said portable agents based on said users of said computer network.

Advantageously, said security policy also includes a definition of said device.

Advantageously, said computer language is a low-level language that is dedicated to operations on said data packets of said computer network and that makes it possible to monitor and to limit the possible actions of said portable agents in said device.

Advantageously, said system includes a server, remote from said device, for defining said security policy.

Advantageously, said device includes administrative means for defining said security policy.

Advantageously, said system includes means for authenticating the non-authenticated user or users of said device.

Advantageously, said security policy also includes a definition of said authenticated users of said device.

Advantageously, said device includes an identification means for authenticating said non-authenticated user or users of said device.

Advantageously, said device includes a server application of a client/server application designed to authenticate said non-authenticated user or users of said device.

Advantageously, said software includes a function library whose functions are called by said executable agents.

Advantageously, said function library also includes specialized functions for managing a cache of said data packets.

Advantageously, said cache of said data packets comprises:

a memory for storing, after the execution of said executable agents, packet information concerning said data packets, and for storing said data packets themselves;

verification means for verifying, based on said packet information stored in said cache, whether an incoming packet is a packet that has already been received and whether it has been modified by said executable agents;

activation means for activating, based on the verifications performed by the verification means,

either transmission means for transmitting a data packet stored in said memory to said computer network without modification

or transmission means for transmitting an incoming packet to said computer network without modification.

Advantageously, said function library also includes specialized functions for managing the network and transport layers of the communication protocol used.

Advantageously, said device comprises:

at least one memory for storing protocol information from said network and transport layers of said data packets passing through said device for the purpose of monitoring the various flows of said data packets and for storing any modifications of said data packets performed by said executable agents;

and means for updating said protocol information from said network and transport layers of said data packets passing through said device, based on said protocol information and said stored modifications, in said data packets so as to maintain consistency in the flows of said data packets.

Advantageously, said function library also includes specialized functions for searching for regular patterns and expressions.

Advantageously, said function library also includes specialized functions for communicating between said executable agents.

Advantageously, said function library includes specialized functions for communicating between said executable agents and said objects of said computer network.

Advantageously, said device includes specialized hardware components associated with functions from said function library, in order to accelerate the execution of said functions.

Advantageously, said executable agents executed by said processor modify said security policy.

The system that is a subject of the present invention thus makes it possible to efficiently implement all of the functionalities of the method described above.

In order to make the invention easier to understand, various examples will be described with the help of the figures. These examples describe, in a purely illustrative way, possible embodiments that do not limit the invention.

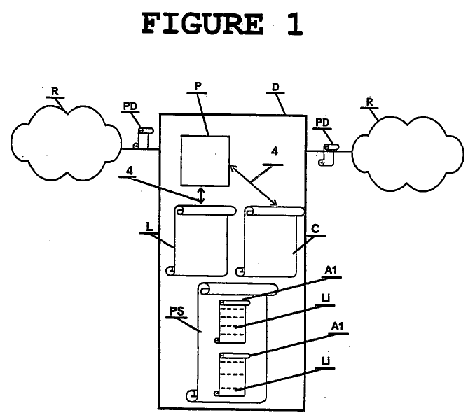

FIG. 1 represents a general diagram of the interconnection of the device active in the invention with a computer network.

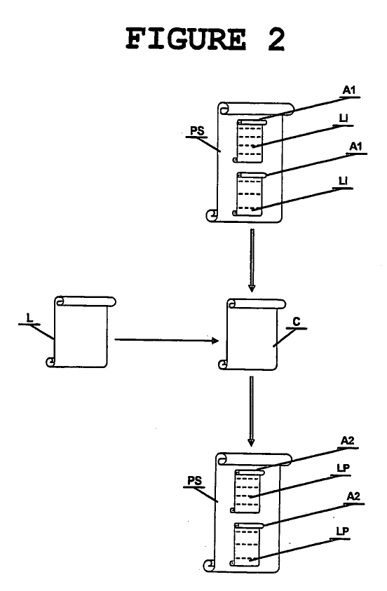

FIG. 2 illustrates the effect of the compilation of the agents inside the device.

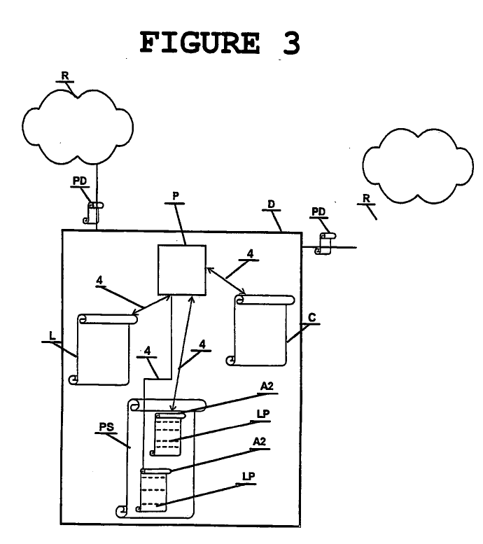

FIG. 3 represents a general diagram of the interconnection of the device active in the invention with a computer network, after the compilation of the portable agents into executable agents.

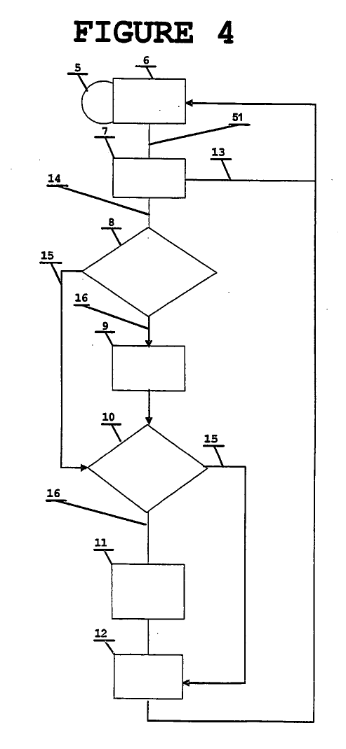

FIG. 4 represents the engine for processing the packets and executing the agents in the device.

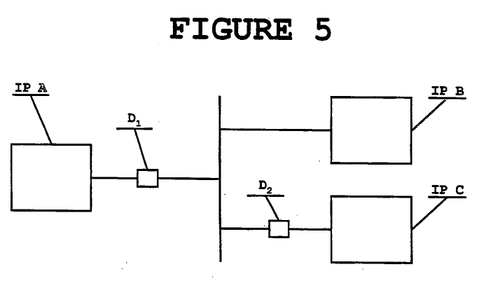

FIG. 5 represents a general diagram of the computer network associated with a security policy.

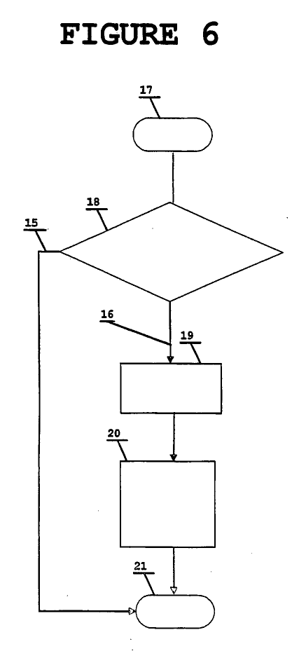

FIG. 6 illustrates the engine of an agent that is capable of modifying the security policy.

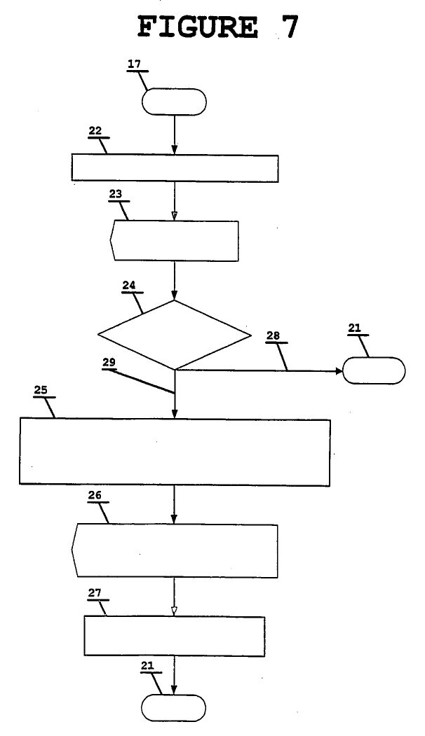

FIG. 7 illustrates a procedure for authenticating a user of the device with a remote server.

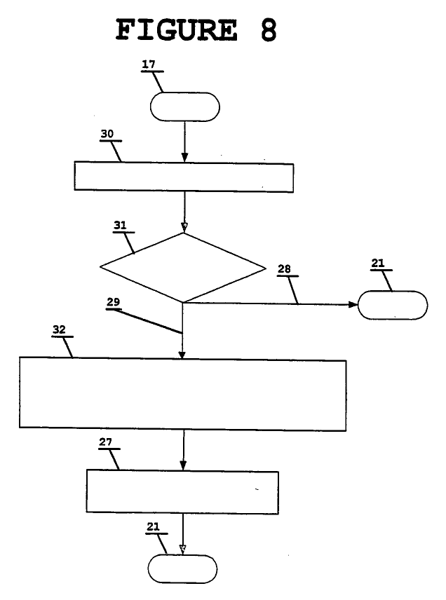

FIG. 8 illustrates a procedure for authenticating a user of the device with an application server in the device.

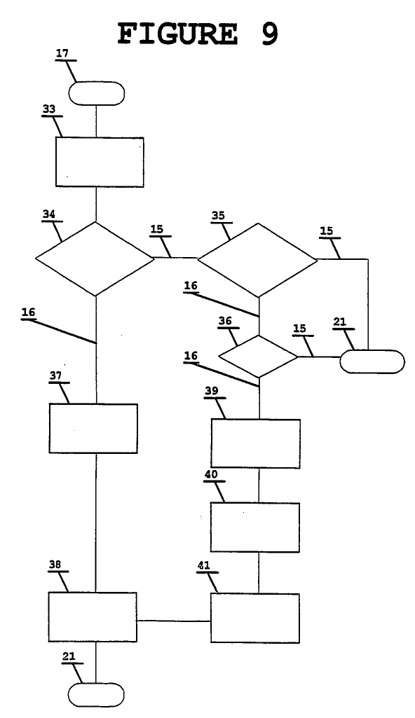

FIG. 9 represents the packet processing engine of an agent.

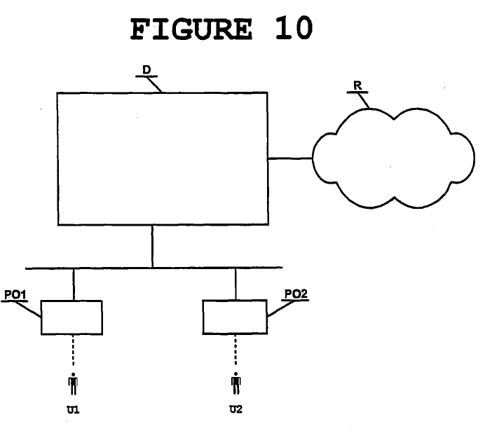

FIG. 10 represents another way of interconnecting the device with a computer network.

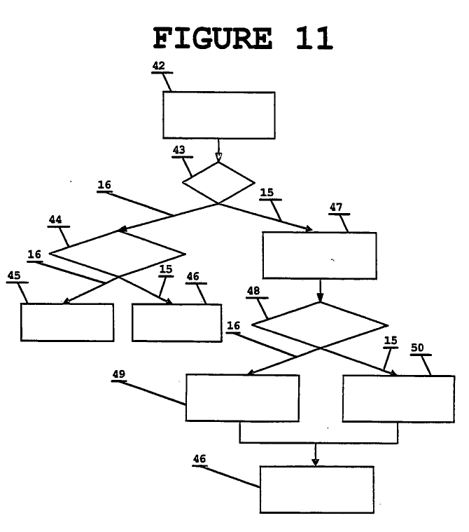

FIG. 11 represents the packet caching engine.

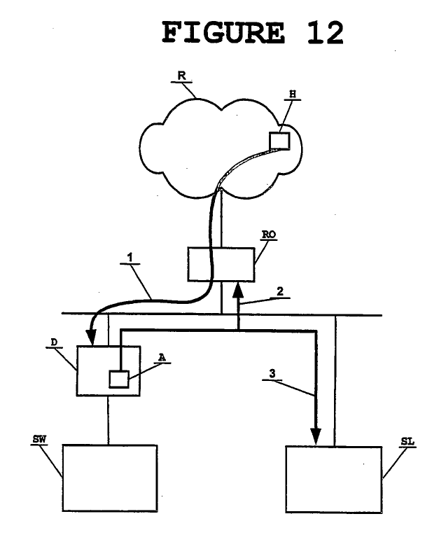

FIG. 12 illustrates an exemplary communication between an agent and various elements of the network.

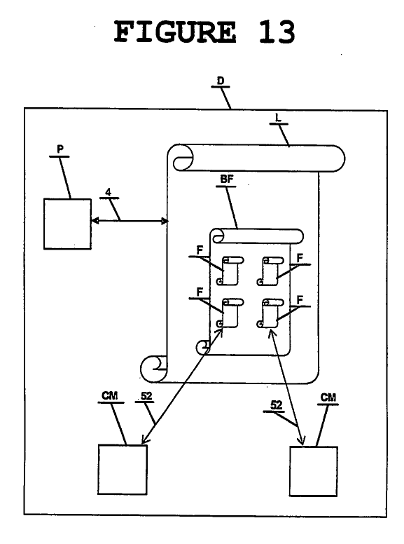

FIG. 13 illustrates the way in which the specialized hardware components can perform certain functions from the function library.

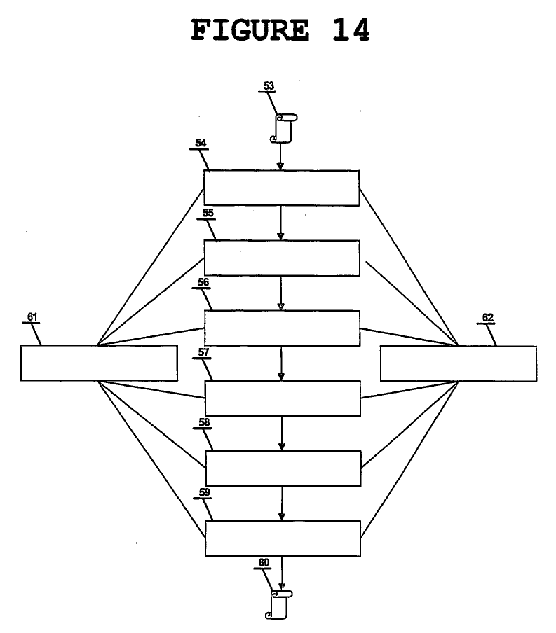

FIG. 14 describes a typical dissection of a compiler.

In FIG. 1, the device D contains a processor P. The device D is placed on an edge of any computer network; it could be a company intranet, the Internet, two adjacent subnetworks or simply two terminals. It could also be a computer connected to a network. The term edge indicates the physical separation of the network R into two subnetworks connected to one another by means of a device D. Thus, any communication flow composed of data packets PD sent from one subnetwork to the other must pass through the device D. This ensures control of any data flow and makes it possible to provide security services and filtering at the level of the device D. This device D also includes a piece of software L and a compiler C, which are designed to be executed 4 by the processor P. The device D also contains a security policy PS. This security policy PS is defined by means of portable agents A1 written in a computer language Li independent of the language of the processor P.

The agent compilation phase is illustrated in FIG. 2. As soon as the security policy PS is present in the device D, the software L automatically calls the compiler C for the purpose of compiling the portable agents A1 that are present in the security policy PS and written in said computer language Li that is independent of the language of the processor P, in order to translate them into executable agents A2 written in the language of the processor P (a language represented by LP). The portable agents A1 cannot be executed by the processor P until they have been compiled into executable agents A2. The executable agents A2 replace the portable agents A1 in the definition of the security policy PS.

FIG. 3 illustrates the state of the device illustrated in FIG. 1 after the compilation, shown in FIG. 2, of the portable agents A1 into executable agents A2. The differences relative to FIG. 1 are as follows:

The portable agents A1 defining the security policy PS are replaced by the executable agents A2 written in the language of the processor P (a language represented by LP), which are in their compiled versions.

The executable agents A2 are then executed 4 by the processor P, in the same way as the software L and the compiler C.

The executable agents A2 are then at the same level as the software L and are executed 4 by the processor P. Unlike in mobile codes (or applets in computer jargon), there is no software abstraction layer (like a virtual machine). The executable agent A2 brings a new functionality to the device D, and everything proceeds as though this functionality were already present in the software L.

The portable agents A1 can be developed in a high-level language (like the “C” language defined by ISO/IEC standard 9899:1999) or an intermediate-level language (like that of the assembler), then translated, if necessary, into a low-level language that is independent of the language of the processor P of said device D. The compiler C makes it possible to perform verifications on the portable agents A1, in order to restrict them in their execution environment and to protect the device D from portable agents A1 that are ill-intentioned or badly coded. Thus, an executable agent A2 cannot, for example, use all of the functions from the library of the software L, and/or cannot access the entire working memory and/or storage of the device D.

The software L performs all of the operations in the device D; for example, it may, depending on the utilization in question, authenticate the users of the device D, retrieve a security policy PS, retrieve along with this security policy portable agents A1 that specialize in certain security functions, retrieve the data packets PD, filter the data packets in accordance with said security policy, etc.

In FIG. 4, the packet processing engine of the software L is illustrated. The following elements constitute this figure:

5: No packet received

6: Waiting for the arrival of a packet

51: Packet received

7: Filter the packet

8: Are there executable agents A2 that apply to the packet?

9: Execute the executable agents A2

10: Are there secondary operations?

11: Perform the secondary operations on the packet

12: Send the packet

13: Packet rejected

14: Packet authorized

15: No

16: Yes

The software L waits for the arrival of new packets. After reception, it verifies whether the packet conforms to the security policy PS and filters the packet, authorizing or not authorizing its passage. If the packet is authorized, the software L verifies whether there are executable agents A2 that apply to the packet in accordance with the security policy, and if so, said executable agent agents A2 are executed. Optionally, the packet may then be subjected to additional operations (encryption, etc.). After processing, if authorized by the executable agents A2, the packet is sent to the destination; otherwise it is destroyed.

In order to allow the software L to determine whether agents should be called to perform additional operations on the packets, the security policy must be able to contain a definition of the agents and their relationships to the other elements of the security policy.

It is possible to design a conventional security policy (for a network using the TCP/IP standard), based on actions for authorizing and rejecting packets based on the source and destination IP addresses, the source and destination ports, and the transport protocol, while adding a list of agents to be executed. The following table is just one example of a security policy, and the agents indicated in this security policy are themselves given merely as an example.

| | Desti- | | | | | |
|---|---|---|---|---|---|---|
| Source | nation | | | | | |
| address | address | Service | Port | Protocol | Action | Agent |
| IP A | IP B | FTP | 1 | TCP | Authorized | FTP Agent |
| IP A | IP C | POP3 | 10 | TCP | Authorized | SSOn |
| | | | | | Encrypted | POP3 Agent |
| IP A | IP C | SMTP | 25 | TCP | Authorized | — |
| | | | | | Encrypted | |
| IP A | IP C | HTTP | 80 | TCP | Authorized | Parental |
| | | | | | | Control |
| All | All | All | * | All | Rejected | — |

It may be seen in this table that any communication flow between Internet addresses other than IP A, IP B and IP C is prohibited (last line of the table). The communication flow between the addresses IP B and IP C is also prohibited (there is no explicit rule authorizing communication between B and C, so the last line prevails). Between the Internet addresses IP A and IP B, all of the communication flow is prohibited except for the FTP service (File Transfer Protocol), to which has been added an FTP Agent responsible for detecting the dynamic port negotiation procedure of the FTP protocol. And between the addresses IP A and IP C all of the flow is prohibited except for:

the POP3 service (for receiving email, Post Office Protocol—Version 3:RFC 1939), which is authorized and which, in this example, must be encrypted, and to which has been added the SSOn POP 3 agent responsible for detecting the authentication procedure and automatically inserting the user's password,

the SMTP service (Simple Mail Transfer Protocol—RFC 821), which is authorized and which, in this example, must be encrypted,

the HTTP service (HyperText Transfer Protocol—RFC 2068, for browsing Internet pages), which is authorized and to which a parental control is applied.

FIG. 5 represents a diagram of a network that can be used in the case where the security policy described in the above table is applied. This network comprises three hosts represented by the Internet addresses IP A, IP B, and IP C; these hosts are connected to the same network. Two devices D1 and D2 are positioned, respectively, between the host with the address IP A and the rest of the network and between the host with the address IP C and the rest of the network. Thus, the hosts with the addresses IP A and IP B (as well as IP B and IP C) have only one device that separates them, while the hosts with the addresses IP A and IP C have the two devices separating them.

FIG. 6 explains the operation of the FTP agent responsible for detecting the dynamic port negotiation procedure. The following elements constitute this figure:

15: No

16: Yes

17: Start

18: Detection of a dynamic port opening negotiation

19: Retrieval of IP B and the port X

20: Modification of the security policy by adding a rule

21: End.

In order to better understand the usefulness of the exemplary FTP agent used in FIG. 6, it is necessary to explain the FTP protocol. This protocol is divided into two separate communication flows: the first is the control flow, which makes it possible to send the commands to the server and receive the responses. This flow normally uses the port TCP 21. The second is the data flow of the files sent. The port that makes it possible to retrieve this second flow is initially unknown, since it is negotiated in the first flow, which makes it impossible to pre-authorize the FTP data flow during the phase for defining the security policy.

The agent is called for each FTP packet. It is responsible for detecting the phase for negotiating a dynamic port for the FTP data flow in the initial communication flow. Once it has detected it, the agent retrieves the address IP B and the negotiated port, in this case X. Then, it modifies the security policy by adding a temporary rule authorizing this flow to pass through.

| | Desti- | | | | | |
|---|---|---|---|---|---|---|
| Source | nation | | | Pro- | | |
| address | address | Service | Port | tocol | Action | Agent |
| IP A | IP B | FTP | 21 | TCP | Authorized | FTP Agent |
| IP A | IP C | POP3 | 110 | TCP | Authorized | SS0n POP3 |
| | | | | | Encrypted | Agent |
| IP A | IP C | SMTP | 25 | TCP | Authorized | — |
| | | | | | Encrypted | |
| IP A | IP C | HTTP | 80 | TCP | Authorized | Parental |
| | | | | | | Control |
| IP A | IP B | FTP Data | X | TCP | Authorized | — |
| All | All | All | * | All | Rejected | — |

We can see in the above table that the FTP agent, after detecting the dynamic port negotiation, has added a rule to the security policy, allowing the hosts with the addresses IP A and IP B to send each other files via the negotiated port (X in our example).

Moreover, the security policy of the device D can be based on the user or users that are identified in the device. In that case, there are several possible methods of implementation. Two methods are illustrated: a method linked to a remote authentication server (FIG. 7), and another method linked to a local authentication (FIG. 8).

The following elements constitute FIG. 7:

17: Start

21: End

22: A user Uᵢ is authenticated in the device D via an identification means.

23: The authentication is sent to the remote server.

24: The authentication is verified by the remote server.

25: The remote server extracts:

The security policy (PS) relative to the user Uᵢ

The corresponding portable agents A1

The corresponding configuration parameters

26: The security policy PS, the portable agents A1, and the configuration parameters are sent to the device.

27: The security policy PS, the configuration parameters, and the executable agents A2 obtained after the compilation of the portable agents A1 by the compiler C are stored.

28: Authentication rejected.

29: Authentication accepted.

In FIG. 7, a user Uᵢ is authenticated in the device D (this can be done by, among other things, a smart card reader or a biometric identification system). The authentication is sent to the remote server, which verifies the authentication of the user. If this authentication is rejected, the server cuts off the communication. On the other hand, if the authentication is authorized, the server constructs the security policy PS relative to the user Uᵢ, including in it the corresponding portable agents A1 and configuration parameters. The server then sends all of this information to the device D, which stores it (for example in memory). The user is then authenticated and can use the device with his own security policy.

This method makes it possible to centralize all the security policies PS of all the devices D in one or more central servers in which administration can be performed globally. This method also makes it possible to send new portable agents A1 and thereby completely modify the behavior of all or some of the devices D.

The following elements constitute FIG. 8:

17: Start

18: End

27: The security policy PS, the configuration parameters, and the agents A2 obtained after the compilation of the portable agents A1 by the compiler C are stored.

28: Authentication rejected

29: Authentication accepted

30: A user Uᵢ is authenticated in the device D by means of a client/server application whose server application is located in the device D.

31: The authentication is verified by the device D

32: The application server extracts:

The security policy PS relative to the user Uᵢ

The corresponding portable agents A1

The corresponding configuration parameters.

In FIG. 8, a user is authenticated via a server application (for example an HTTP server) included in the software L of the device. The server application verifies the authentication. If the latter is correct, the server application retrieves and then activates the security policy PS for the user Uᵢ (as in FIG. 7). The information is contained directly in the device D. It is possible to parameterize these functionalities and, more generally, the security policy PS, relative to the user Uᵢ . Administration is performed locally in the device D via the server application. This method can be used in the context of a single device D for a family network that accesses the Internet or for a small business.

FIGS. 7 and 8 are merely exemplary implementations of the invention. It is entirely possible to combine these two examples and to have the user authentication done via a (Web or other) server embedded in the device D, and to have a central server that verifies this authentication, generates the security policy, then transmits it to the device D.

Services other than conventional packet filtering performed by a conventional firewall are performed by the agents. An agent can potentially perform any operation on the packets. The following example shows how easy it is to implement an agent.

FIG. 9 illustrates the engine of an agent that performs a highly original security functionality at the application level (and not at the TCP/IP level, for example). The following elements constitute this figure:

15: No

16: Yes

17: Start

21: End

33: Initialization of the agent

34: Does the packet contain the “USER” command?

35: Does the packet contain the “PASS” command?

36: Is there a password associated with the user name?

37: Retrieval and storage of the user name

38: Saving of the agent's parameters

39: Calculation of the size of the data to be added to the packet

40: Modification of the size of the packet

41: Insertion of the password into the packet

This agent is responsible for performing the authentication of a user in his email server via the POP3 protocol (Post Office Protocol—Version 3: RFC 1939); POP3 authentication commands: RFC 1734). The user no longer needs to know his password. The agent is responsible for inserting the password in accordance with the user's identifier.

The engine of the agent is relatively simple. The agent searches for a packet containing the USER command and extracts the user's identifier if the command is found. Next, it searches for a packet containing the PASS command. Once it has found it, the agent retrieves the password corresponding to the identifier, calculates the size to be added to the packet, enlarges the packet and inserts the valid password.

Here is an example of this code, written in the high-level computer language “C”:

```
int main( )
{
  /* definition of the variables */
  int packet_size;
  char  *packet
  char * (param[6]);
  int error, login_size, offset, pass_size;
  /* Retrieval of the packet and the parameters of
    the agent */
  if  (  !(  packet  = agent_getPacketData(&packet_size)))
    return OK;
  agent_getAgentParam ( param);
  /* Search for the USER command in order to
  retrieve the login */
  if ( !strncmp( packet, “USER”, 5))
  {
    login_size = size − 7;
    if (login_size > 32)
    return −1;
    /* Save the login and its size */
    strncpy( param[1] , packet + 5, login_size);
    (int) (param[2]) = login_size;
  }
  /* Search for the PASS command in order to insert
  the password */
  if ( !strncmp( packet, “PASS”, 5))
  {
    /* Retrieve the password corresponding to the
    login */
    if ( (offset = agent_getMatch( param[0], param[1],
      (int) (param[2]))) == −1)
      return OK;
    pass_size = strlen ( param[0] + offset);
    /* Increase the size of the packet and insert the
    password */
    agent_modifyMemSpace( packet + 5, pass_size);
    strncpy( packet + 5, param[1], pass_size);
  }
  /* Save the parameters of the agent */
  agent_saveAgentParam( param);
  return OK;
}
```

This example clearly shows how the invention makes it easier to add new security and/or network management functionalities in the device D. In a few lines of code, it is possible to perform operations on the packets. Given the ease of access to the packets of the communication flows, the agent can quickly read and modify the data in the packets. Thus, any developer can write his own agents and increase his functionality base. As new threats emerge, new agents that detect these threats and eliminate them are implemented quickly and efficiently. Broadcasting to all of the devices protects the entire network population homogeneously and instantaneously. For services such as the one described above, a global security policy can be deployed in the same way throughout a computer network.

FIG. 10 illustrates another embodiment of the invention. Two users U1 and U2, at two different terminals PO1 and PO2, are identified in the device D and have their own security policies. Any communication flow coming from the network R to one of these terminals is filtered in accordance with the security policy that corresponds to the user of the terminal.

This example does not limit the present invention to two users. The present invention is capable of protecting as many terminals and/or users as desired, using different security policies PS for each of them, if desired.

In order to optimize the execution of the executable agents A2 on the packets, a packet cache makes it possible to send the executable agents A2 only one version of the same packet, thus presenting them with a coherent flow. The packet cache makes it possible to handle the packets already received in such a way as not to disturb the algorithms of the agents, which are not expecting to re-receive a packet that has already been processed. These phenomena are known as packet retransmissions and are present at the level of the TCP protocol.

FIG. 11 shows a general packet caching engine. The following elements constitute this figure:

15: No

16: Yes

42: Arrival of a packet in the device

43: Has the packet already been received?

44: Has the packet been previously modified by the agents?

45: Sending of the saved modified packet

46: Sending of the packet

47: Processing by the agents

48: Has the packet been modified by the agents?

49: Store the packet and the information identifying it

50: Store the information identifying the packet.

When a packet is received (42), the packet cache verifies whether the packet has been received before (43). If not, the agents that apply to the packet are called (47). Once processed, the information that makes it possible to identify the packet (for example, its TCP sequence number) is saved ((49) or (50)). If the packet is modified by the agents, the modified packet is saved with the information identifying it (49), and then it is sent to the network (46). If not, it is simply sent to the network (46), after the information that identifies it has been saved (50). If the packet has already been received (i.e., if the information identifying it is found in the packet cache), the packet cache verifies whether the modified packet has been saved (44), in which case the modified packet is sent to the network without executing the agents (45). If not, the already received packet is sent directly to the network without executing the agents (46). This guarantees that the agents will not re-receive a packet that they have already processed.

Let's illustrate one particular possible case: an agent responsible for detecting a virus suspects the presence of a virus in a packet 1, but needs to perform an analysis of the packet 2 in order to be convinced. If the packet 1 is being received for the second time (packet 1a), the agent will perform the operation of the packet 2 on this packet 1a, which will invalidate the analysis. The packet cache makes it possible to send on the right version of the packet 1 directly, without executing the agents. There are two possible scenarios: the packet 1 either was or was not modified by an agent the first time it was received. In the former case, the modified packet 1 was saved the first time. It is the saved version that is sent on, without executing the agents. In the latter case, the packet 1a is send on directly without executing the agents.

The agents have a number of packet processing functions. But they also have functions that allow them to communicate with all the constituent elements of the network. These functions are indispensable in implementing a global security policy for the network.

FIG. 12 demonstrates the advantage of this. Let's consider a network R that is not very secure, in which a computer hacker is operating from a terminal H. This hacker develops an attack (1) to be sent to a company's web server SW, this web server being accessible via a router RO. The web server SW is protected by the device D (using the invention). The agent A is responsible for securing the web server. When an attack (1) is detected, the agent A blocks the attack (1) and sends an order (2) to reconfigure the router RO in order to block the communications coming from the terminal H (for example via the SNMP protocol). It then sends a warning message (3) to the log server SL, which maintains a centralized event log (for example via the syslog protocol). Thus, the device D is reactive to attacks, and it can communicate to the other network peripherals any information that impacts the security of the network.

FIG. 13 illustrates the use of functions F from a function library BF contained in the software L; some of these functions F can be associated with specialized hardware components CM present in the device D. The processor P contained in the device D executes 4 the software L. The software L calls functions F contained in the function library BF. These functions F can be coded in the form of software executed by the processor P. They can also use (52) specialized hardware components CM that are associated with them.

FIG. 14 describes the various phases of a compiler. It is constituted by the following elements:

53: source program

54: lexical analyzer

55: syntactic analyzer

56: semantic analyzer

57: intermediate code generator

58: code optimizer

59: code generator

60: target program

61: symbol table manager

62: error manager.

A source program (53) written in one language is transformed by the compiler into a target program (60) written in another, lower-level language (closer to the machine language). The source program runs through the following phases:

analysis: Three analyzers constitute this analysis phase, the lexical (54), syntactic (55) and semantic (56) analyzers, which break the code down into lexical units, sort them hierarchically, and check to see whether or not there are syntactic errors.

intermediate code generation: The source program is transformed by the intermediate code generator (57) into intermediate code that is easy to produce and easy to translate into the target language.

optimization: A code optimizer (58) attempts to improve the intermediate code so that the resulting code is executed faster.

code generation: A code generator (59) then produces the target program (60).

All of the phases described above use the of the symbol table manager (61) and the error manager (62). The former records the identifiers used in the source program and collects information on various attributes of each identifier. The latter manages the errors emerging from the various phases that process them, so that the compilation can be continued in order to detect other possible errors.

1-46. (canceled)

47. A method for analyzing or selectively modifying or filtering data packets passing through a device placed on an edge in a computer network, said device comprising a processor that runs a compiler and a piece of software in accordance with a security policy, said software being designed to filter said data packets, thereby authorizing or not authorizing their passage in accordance with said security policy, the method comprising the steps of:
defining said security policy by portable agents written in a computer language that is independent of the language of said processor and for analyzing, selectively modifying or selectively filtering said data packets;
automatically calling said compiler by said software in order to perform a compilation for translating said portable agents into executable agents written in the language of said processor;
running said software in order to filter said data packets passing through said device, thereby authorizing or not authorizing their passage in accordance with said security policy; and
performing at least one of the following steps:
analyzing said data packets authorized by said software to pass through said device, by executing said executable agents by said processor;
selectively modifying said data packets authorized by said software to pass through said device, by executing said executable agents by said processor; or
selectively filtering said data packets authorized by said software to pass through said device, by executing said executable agents by said processor.

48. The method of claim 47, wherein said security policy comprises a definition of various objects of said computer network.

49. The method of claim 47, wherein said security policy comprises a definition of various services of said computer network.

50. The method of claim 47, wherein said security policy comprises a definition of various users of said computer network.

51. The method of claim 50, further comprising the step of generating configuration parameters, thereby enabling the configuration of said portable agents based on said users of said computer network.

52. The method of claim 47, wherein said security policy comprises a definition of said device.

53. The method of claim 47, wherein said computer language is a low-level language that is dedicated to operations on said data packets of said computer network, thereby monitoring and limiting the possible actions of said portable agents inside said device.

54. The method of claim 47, further comprising the step of defining said security policy in a server remote from said device.

55. The method of claim 47, further comprising the step of defining said security policy in said device.

56. The method of claim 47, further comprising the step of authenticating the non-authenticated user of said device to provide an authenticated user of said device.

57. The method of claim 56, wherein said security policy comprises a definition of said authenticated user of said device.

58. The method of claim 57, wherein the step of authenticating uses an identification means associated with said device to authenticate said non-authenticated user of said device.

59. The method of claim 57, wherein the step of authenticating uses a server application of a client/server application in said device to authenticate said non-authenticated user of said device.

60. The method of claim 47, further comprising the step of executing functions from a function library of said software and called by said executable agents.

61. The method of claim 60, further comprising the step of executing specialized functions from said function library for managing a cache of said data packets.

62. The method of claim 61, wherein the step of executing specialized functions further comprises the steps of:
storing in said cache, after the execution of said executable agents, packet information concerning said data packets and said data packets if said data packets have been modified during the execution of said executable agents;
verifying whether an incoming packet in said device is a packet that has already been received by said device based on said packet information stored in said cache;
executing said executable agents if it is determined that said incoming packet is not a packet that has already been received by said device;
determining whether said incoming packet has been modified by said executable agents using said packet information stored in said cache if it is determined that said incoming packet is a packet that has already been received;
transmitting a version of said incoming packet stored in said cache to said computer network without executing said executable agents if it is determined that said already received packet has been modified by said executable agents; and
transmitting said incoming packet to said computer network without executing said executable agents if it is determined that said incoming packet has not been modified by said executable agents.

63. The method of claim 60, further comprising the step of executing specialized functions from said function library for managing said computer network and transport layers of the communication protocol used.

64. The method of claim 63, wherein the step of executing specialized functions comprises the steps of:
storing protocol information from said computer network and said transport layers of said data packets passing through said device to monitor various flows of said data packets;
storing any modifications of said data packets performed by said executable agents;
updating said protocol information from said computer network and said transport layers of said data packets passing through said device, based on said protocol information and said stored modifications, in said data packets so as to maintain consistency in the flows of said data packets.

65. The method of claim 60, further comprising the step of executing specialized functions from said function library for searching for regular patterns and expressions.

66. The method of claim 60, further comprising the step of executing specialized functions from said function library for communicating between said executable agents.

67. The method of claim 60, further comprising the step of executing specialized functions from said function library for communicating between said executable agents and objects of said computer network.

68. The method of claim 60, further comprising the step of associating specialized hardware components of said device with functions of said function library to accelerate the execution of said functions.

69. The method of claim 47, further comprising the step of modifying said security policy by executing said executable agents by said processor.

70. A system for analyzing or selectively modifying or filtering data packets, comprising:
a device placed on an edge in a computer network, said device comprising a processor that runs a compiler and a piece of software in accordance with a security policy, said software comprising a filter for filtering said data packets passing through said device, thereby authorizing or not authorizing the passage of said packets in accordance with said security policy, and
portable agents for defining said security policy written in a computer language that is independent of the language of said processor and for analyzing or selectively modifying or filtering said data packets; and
wherein said software is operable to automatically activate said compiler to translate said portable agents into executable agents written in the language of said processor; and
wherein said process is operable to execute said executable agent to perform at least one of the following:
analyze said data packets authorized by said software to pass through said device;
selectively modify said data packets authorized by said software to pass through said device; or
selectively filter said data packets authorized by said software to pass through said device.

71. The system of claim 70, wherein said security policy comprises a definition of various objects of said computer network.

72. The system of claim 70, wherein said security policy comprises a definition of various services of said computer network.

73. The system of claim 70, wherein said security policy comprises a definition of various users of said computer network.

74. The system of claim 73, further comprising a module for generating configuration parameter for configuring said portable agents based on said users of said computer network.

75. The system of claim 70, wherein said security policy comprises a definition of said device.

76. The system of claim 70, wherein said computer language is a low-level language that is dedicated to operations on said data packets of said computer network thereby monitoring and limiting the possible actions of said portable agents in said device.

77. The system of claim 70, further comprising a server, remote from said device, for defining said security policy.

78. The system of claim 70, wherein said device comprises an administrative module for defining said security policy.

79. The system of claim 70, further comprising an authentication device for authenticating non-authenticated user or users of said device to provide an authentication user of said device.

80. The system of claim 79, wherein said security policy comprises a definition of said authenticated users of said device.

81. The system of claim 80, wherein said device comprises an identification device for authenticating said non-authenticated user of said device.

82. The system of claim 80, wherein said device comprises a server application of a client/server application operable to authenticate said non-authenticated user of said device.

83. The system of claim 70, wherein said software comprises a function library comprising functions callable by said executable agents.

84. The system of claim 83, wherein said function library comprises specialized functions for managing a cache of said data packets.

85. The system of claim 84, wherein said cache of said data packets comprises:
a memory for storing, after the execution of said executable agents, packet information concerning said data packets, and said data packets;
a verification module for verifying, based on said packet information stored in said cache, whether an incoming packet is a packet that has already been received and whether said incoming packet has been modified by said executable agents; and
an activation module for activating a transmitter for transmitting said incoming data packet stored in said memory to said computer network without modification if it is determined that said incoming packet has been modified by said verification module or a transmitter or for transmitting said incoming packet to said computer network without modification if it is determined that said incoming packet has not been modified by said verification means.

86. The system of claim 83, wherein said function library comprises specialized functions for managing the network and transport layers of the communication protocol used.

87. The system of claim 86, wherein said device comprises:
at least one memory for storing protocol information from said computer network and said transport layers of said data packets passing through said device for monitoring various flows of said data packets and storing any modifications of said data packets performed by said executable agents; and
a module for updating said protocol information from said computer network and said transport layers of said data packets passing through said device, based on said protocol information and said stored modifications, in said data packets so as to maintain consistency in the flows of said data packets.

88. The system of claim 83, wherein said function library comprises specialized functions for searching for regular patterns and expressions.

89. The system of claim 83, wherein said function library comprises specialized functions for communicating between said executable agents.

90. The system of claim 83, wherein said function library comprises specialized functions for communicating between said executable agents and objects of said computer network.

91. The system of claim 83, wherein said device comprises specialized hardware components associated with functions of said function library to accelerate the execution of said functions.

92. The system of claim 70, wherein said executable agents executed by said processor is operable to modify said security policy.
